(19) United States
(12) Patent Application Publication
(10) Pub. No.: US 2024/0062948 A1
(43) Pub. Date: Feb. 22, 2024

(54) COIL COMPONENT

(71) Applicant: TDK Corporation, Tokyo (JP)

(72) Inventors: Tomonaga NISHIKAWA, Tokyo (JP); Ichiro YAGINUMA, Tokyo (JP); Takemichi HOSHI, Tokyo (JP); Mitsunori HIRAOKA, Tokyo (JP); Hiroki SHIBA, Tokyo (JP)

(21) Appl. No.: 18/366,293

(22) Filed: Aug. 7, 2023

(30) Foreign Application Priority Data
Aug. 18, 2022 (JP) 2022-130392

(51) Int. Cl. H01F 27/29; H01F 27/24

(52) U.S. Cl. CPC H01F 27/292; H01F 27/24

(57) ABSTRACT

Disclosed herein is a coil component that includes, first and second magnetic element bodies, first and second coil conductors embedded respectively in the first and second magnetic element bodies, first and second terminal electrodes exposed from the first magnetic element body and connected respectively to one end and other end of the first coil conductor, third and fourth terminal electrodes exposed from the second magnetic element body and connected respectively to one end and other end of the second coil conductor, and a low-permeability layer provided between the first and second magnetic element bodies and being lower in permeability than the first and second magnetic element bodies.

### BACKGROUND OF THE ART

### Field of the Art

The present disclosure relates to a coil component and, more particularly, to a coil component that can be used as a coupled inductor.

### Description of Related Art

A coil component called a coupled conductor is sometimes used as a smoothing coil for a switching power supply such as a DC-DC converter. The coupled inductor has a pair of current paths which are magnetically coupled to each other. When current is made to flow to one current path, the current flows also to the other current path by means of electromotive force. Thus, using this coupled inductor as a smoothing coil for a switching power supply allows reduction in the peak of inrush current. As such a coupled inductor, one described in JP 2009-117676A is known.

However, the coupled conductor described in JP 2009-117676A has a bar-like coil conductor and thus has a difficulty in obtaining a high inductance. To achieve a higher inductance, a spiral coil pattern may be used as described in JP 2016-131208A; however, a coil component described in JP 2016-131208A has a structure in which two element bodies each embedding therein a coil conductor are merely bonded to each other, making it difficult to adjust a coupling coefficient. In addition, the coil component described in JP 2016-131208A uses a non-magnetic material for an element body, making it difficult to obtain a sufficient inductance.

### SUMMARY

It is therefore an object of the present disclosure to provide a coil component capable of achieving a high inductance and easily adjusting a coupling coefficient.

A coil component according to the present disclosure includes: first and second magnetic element bodies; first and second coil conductors embedded respectively in the first and second magnetic element bodies; first and second terminal electrodes exposed from the first magnetic element body and connected respectively to one end and the other end of the first coil conductor; third and fourth terminal electrodes exposed from the second magnetic element body and connected respectively to one end and the other end of the second coil conductor; and a low-permeability layer provided between the first and second magnetic element bodies and being lower in permeability than the first and second magnetic element bodies.

### BRIEF DESCRIPTION OF THE DRAWINGS

The above features and advantages of the present disclosure will be more apparent from the following description of certain preferred embodiments taken in conjunction with the accompanying drawings, in which:

FIG. 1 is a schematic perspective view illustrating the outer appearance of a coil component 100 according to a first embodiment of the present disclosure;

FIG. 2 is a schematic XZ cross-sectional view of the coil component 100;

FIG. 3 is a schematic plan view illustrating the pattern shape of the conductor layer L3;

FIG. 4 is an equivalent circuit diagram of the coil component 100;

FIG. 5 is an enlarged view of the terminal electrodes 21 and 23 and their surroundings;

FIG. 6 is a view for explaining a first modification;

FIG. 7 is a view for explaining a second modification; and

FIG. 8 is a schematic perspective view illustrating the outer appearance of a coil component 200 according to a second embodiment of the present disclosure.

### DETAILED DESCRIPTION OF THE EMBODIMENTS

Preferred embodiments of the present disclosure will be explained below in detail with reference to the accompanying drawings.

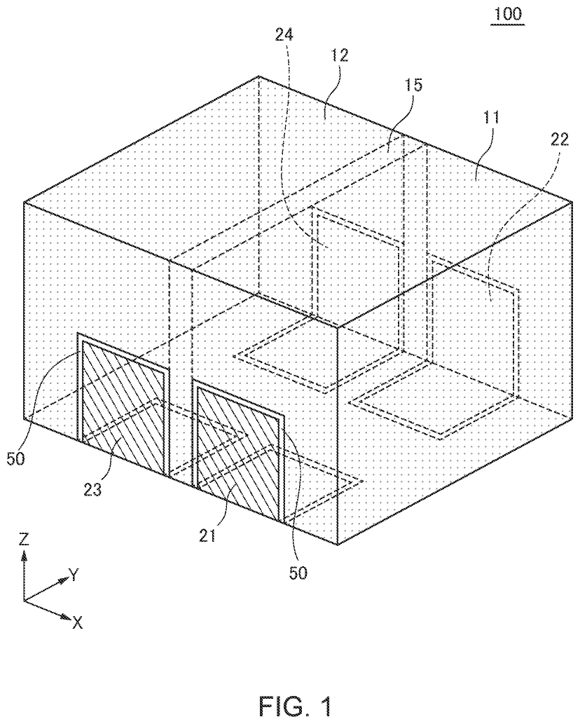

FIG. 1 is a schematic perspective view illustrating the outer appearance of a coil component 100 according to a first embodiment of the present disclosure.

As illustrated in FIG. 1, the coil component 100 according to the present embodiment has magnetic element bodies 11 and 12 arranged in the X-direction, a low-permeability layer 15 disposed between the magnetic element bodies 11 and 12, and the terminal electrodes 21 to 24. The magnetic element bodies 11 and 12 are each made of a composite magnetic material containing magnetic filler made of a magnetic metal body and a resin binder, inside of each of which a coil conductor to be described later is embedded. As described above, in the present embodiment, the coil conductor is embedded in each of the magnetic element bodies 11 and 12, so that a higher inductance can be achieved as compared with when using an element body made of a non-magnetic element.

One end and the other end of the coil conductor embedded in the magnetic element body 11 are connected respectively to the terminal electrodes 21 and 22 exposed from the magnetic element body 11, and one end and the other end of the coil conductor embedded in the magnetic element body 12 are connected respectively to the terminal electrodes 23 and 24 exposed from the magnetic element body 12. The terminal electrodes 21 and 22 are arranged in the Y-direction, the terminal electrodes 23 and 24 are arranged in the Y-direction, the terminal electrodes 21 and 23 are arranged in the X-direction, and the terminal electrodes 22 and 24 are arranged in the X-direction. The thus arranged terminal electrodes 21 to 24 are all exposed to a mounting surface constituting the XY surface and also to their corresponding XZ side surfaces. However, the terminal electrodes 21 to 24 need not each be exposed to the XZ side surface and may be exposed at least to the mounting surface.

The low-permeability layer 15 is made of a composite magnetic material containing magnetic filler made of a magnetic metal body and a resin binder like the magnetic element bodies 11 and 12, the composite magnetic material being lower in permeability than the magnetic element bodies 11 and 12. The permeability of the composite magnetic material can be adjusted depending on the type, additive amount, and size of magnetic filler to be used.

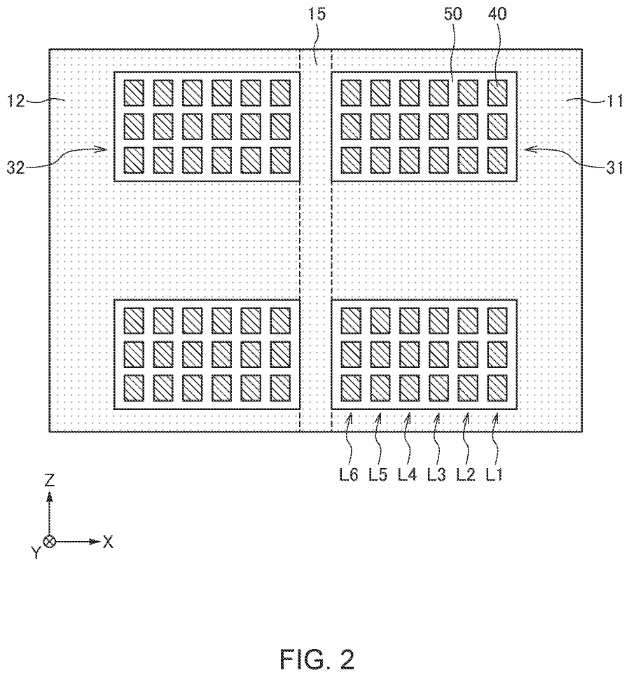

FIG. 2 is a schematic XZ cross-sectional view of the coil component 100.

As illustrated in FIG. 2, a coil conductor 31 is embedded in the magnetic element body 11, and a coil conductor 32 is embedded in the magnetic element body 12. In the example illustrated in FIG. 2, the coil conductors 31 and 32 each have a six-layer structure composed of conductor layers L1 to L6, and a coil pattern 40 is formed in each of the conductor layers L1 to L6. The conductor layers L1 to L6 are made of copper (Cu) or the like. The conductor layers L1 to L6 are stacked in the in the X-direction, and an interlayer insulating film 50 is provided on both sides of each of the conductor layers L1 to L6 in the stacking direction. This ensures insulation between the conductor layers L1 to L6 and prevents the conductor layers L1 to L6 from contacting the magnetic element bodies 11 and 12.

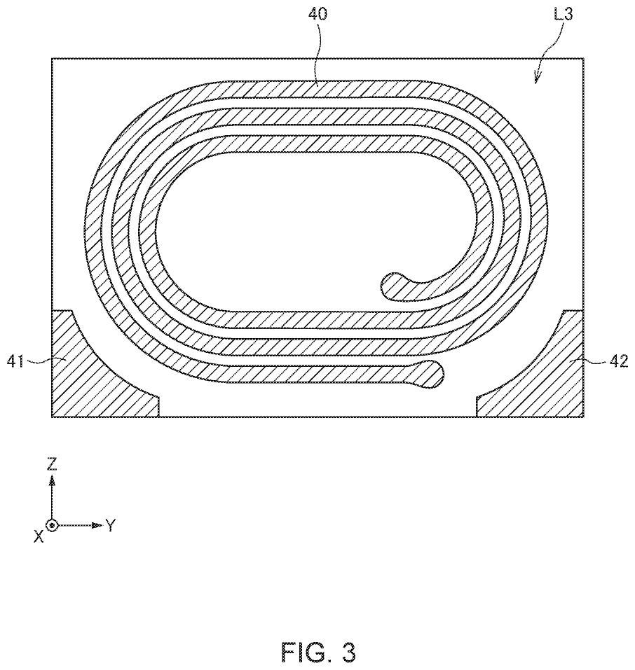

As an example, the pattern shape of the conductor layer L3 is illustrated in FIG. 3. As illustrated in FIG. 3, the conductor layer L3 includes the coil pattern 40 wound in about three turns and terminal electrode patterns 41 and 42. Similarly, the other conductor layers each include the coil pattern 40 wound in a predetermined number of turns and the terminal electrode patterns 41 and 42. The coil patterns 40 included in the respective conductor layers L1 to L6 are connected in series to one another through a via conductor. Further, the outer peripheral end of the coil pattern 40 included in the conductor layer L1 is connected to the terminal electrode pattern 41, and the outer peripheral end of the coil pattern 40 included in the conductor layer L6 is connected to the terminal electrode pattern 42. Thus, the coil conductors 31 and 32 each constitute a single coil.

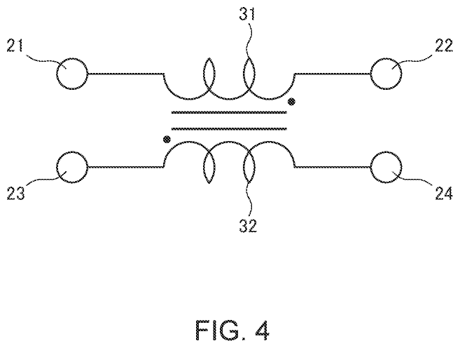

The end surfaces of the respective terminal electrode patterns 41 and 42 are exposed from the magnetic element bodies 11 and 12 to constitute the terminal electrodes 21 to 24. Specifically, the exposed part of the terminal electrode pattern 41 included in the coil conductor 31 constitutes the terminal electrode 21, the exposed part of the terminal electrode pattern 42 included in the coil conductor 31 constitutes the terminal electrode 22, the exposed part of the terminal electrode pattern 41 included in the coil conductor 32 constitutes the terminal electrode 23, and the exposed part of the terminal electrode pattern 42 included in the coil conductor 32 constitutes the terminal electrode 24. In the present embodiment, the circulating direction of current flowing in the coil conductor 31 from the terminal electrode 21 to the terminal electrode 22 and the circulating direction of current flowing in the coil conductor 32 from the terminal electrode 23 to the terminal electrode 24 are reverse to each other. This allows the coil component 100 according to the present embodiment to be used as a coupled inductor in which the coil conductors 31 and 32 are magnetically reversely coupled to each other as illustrated in the equivalent circuit diagram of FIG. 4.

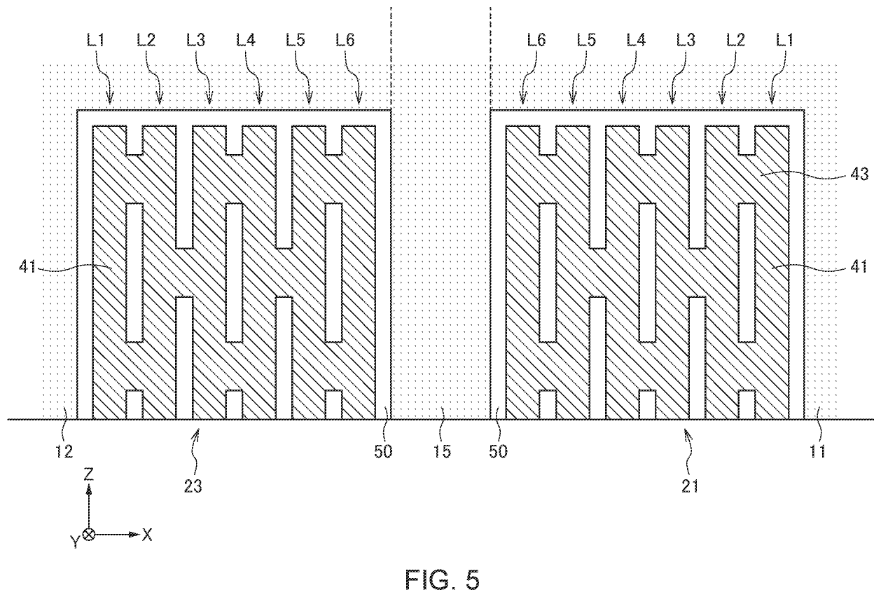

FIG. 5 is an enlarged view of the terminal electrodes 21 and 23 and their surroundings.

As illustrated in FIG. 5, a via conductor 43 connecting the conductor layers L1 to L6 is exposed to the surface of the terminal electrode pattern 41 constituting each of the terminal electrodes 21 and 23. The interlayer insulating film 50 is exposed to a part of the surface of the terminal electrode pattern 41 where the via conductor 43 is not present. The periphery of each of the terminal electrodes 21 and 23 is also surrounded by the interlayer insulating film 50, which prevents the terminal electrodes 21 and 23 from contacting respectively the magnetic element bodies 11 and 12 and enhances the withstand voltage between the terminal electrodes 21 and 23. The same applies to the terminal electrodes 22 and 24.

As described above, in the coil component 100 according to the present embodiment, the low-permeability layer 15 is provided between the magnetic element bodies 11 and 12 having the coil conductors 31 and 32 embedded respectively therein, thereby allowing a coupling coefficient to be adjusted depending on a magnetic material used for the low-permeability layer 15 and the thickness of the low-permeability material layer. Further, it is possible to sufficiently ensure a withstand voltage between the terminal electrodes 21 and 23 and a withstand voltage between the terminal electrodes 22 and 24 despite using the magnetic element bodies 11 and 12 having a low withstand voltage.

The coil component 100 having such a structure can be obtained by separately producing the magnetic element body 11 having the coil conductor 31 embedded therein and the magnetic element body 12 having the coil conductor 32 embedded therein, and then bonding the magnetic element bodies 11 and 12 through the low-permeability layer 15. The magnetic element bodies 11 and 12 may be bonded to each other using an adhesive or by curing an uncured resin binder contained in the low-permeability layer 15.

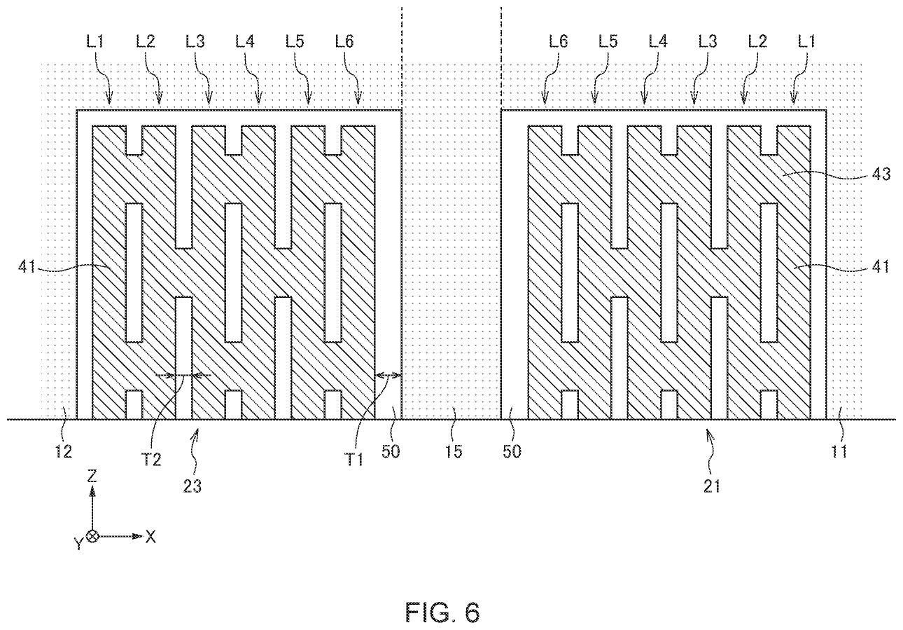

FIG. 6 is a view for explaining a first modification, which illustrates the plane corresponding to that of FIG. 5.

In the first modification illustrated in FIG. 6, a thickness T1 in the stacking direction (X-direction) of the interlayer insulating film 50 positioned between the conductor layer L6 and the low-permeability layer 15 is larger than a thickness T2 in the stacking direction of the interlayer insulating film 50 at other portions. This increases the distance between the terminal electrodes 21 and 23 in the X-direction and the distance between the terminal electrodes 22 and 24 in the X-direction without changing the thickness of the low-permeability layer 15 in the X-direction and increases the thickness of the interlayer insulating film 50 positioned between the terminal electrodes 21 and 23 and between the terminal electrodes 22 and 24, whereby the withstand voltage can be further enhanced.

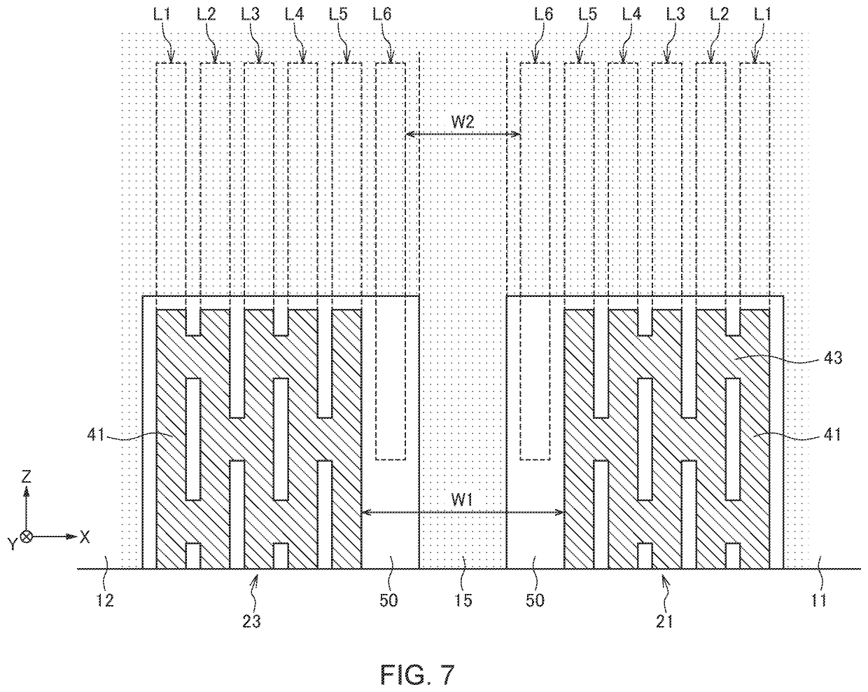

FIG. 7 is a view for explaining a second modification, which illustrates the plane corresponding to that of FIG. 5.

In the second modification illustrated in FIG. 7, the terminal electrode patterns 41 and 42 positioned in the conductor layer L6 are removed. This increases a distance W1 between the terminal electrodes 21 and 23 (22 and 24) in the X-direction to make the distance W1 larger than a distance W2 in the X-direction between the conductor layer L6 belonging to the coil conductor 31 and the conductor layer L6 belonging to the coil conductor 32, thereby making it possible to further enhance the withstand voltage.

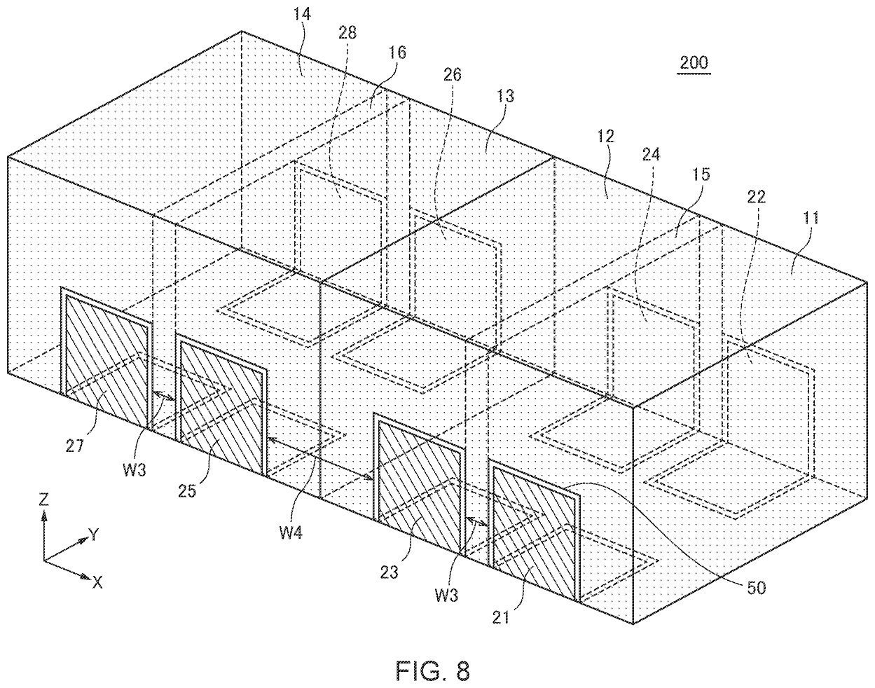

FIG. 8 is a schematic perspective view illustrating the outer appearance of a coil component 200 according to a second embodiment of the present disclosure.

As illustrated in FIG. 8, the coil component 200 according to the second embodiment has a structure obtained by connecting two coil components 100 according to the above-described first embodiment. That is, the coil component 200 includes magnetic element bodies 11 to 14 arranged in the X-direction, a low-permeability layer 16 disposed between the magnetic element bodies 13 and 14, and terminal electrodes 21 to 28. The magnetic element bodies 13 and 14 are made of the same magnetic material as the magnetic element bodies 11 and 12, and the low-permeability layer 16 is made of the same magnetic material as the low-permeability layer 15. That is, a composite magnetic material having a permeability lower than that of the magnetic element bodies 11 to 14 is used for the low-permeability layer 16.

The coil component 200 having such a structure can be used as an array product of two coupled inductors. In addition, a distance W4 between the terminal electrodes 23 and 25 is larger than a distance W3 between the terminal electrodes 21 and 23 and between the terminal electrodes 25 and 27, whereby a sufficient withstand voltage is ensured between different coupled inductors.

While the preferred embodiment of the present disclosure has been described, the present disclosure is not limited to the above embodiment, and various modifications may be made within the scope of the present disclosure, and all such modifications are included in the present disclosure.

The technology according to the present disclosure includes the following configuration examples but not limited thereto.

A coil component according to the present disclosure includes: first and second magnetic element bodies; first and second coil conductors embedded respectively in the first and second magnetic element bodies; first and second terminal electrodes exposed from the first magnetic element body and connected respectively to one end and the other end of the first coil conductor; third and fourth terminal electrodes exposed from the second magnetic element body and connected respectively to one end and the other end of the second coil conductor; and a low-permeability layer provided between the first and second magnetic element bodies and being lower in permeability than the first and second magnetic element bodies.

According to the present disclosure, the low-permeability layer is provided between the two magnetic element bodies each having the coil conductor embedded therein, allowing a coupling coefficient to be adjusted depending on a magnetic material used for the low-permeability layer and the thickness of the low-permeability material layer. In addition, the coil conductor is embedded in the magnetic element body, allowing achievement of a high inductance.

In the present disclosure, the first and second coil conductors may each include a plurality of coil patterns stacked through an interlayer insulating film, the first and second terminal electrodes may be separated from the first magnetic element body through the interlayer insulating layer, and the third and fourth terminal electrodes may be separated from the second magnetic element body through the interlayer insulating layer. This enhances a withstand voltage between the terminal electrodes.

In the present disclosure, the plurality of coil patterns may be stacked in the arrangement direction of the first and second magnetic element bodies. Thus, even when the number of layers of the coil patterns is large, the size of the magnetic element body in the height direction can be suppressed.

In the present disclosure, the distance between the first and third terminal electrodes in the stacking direction may be larger than the distance between the first and second coil conductors in the stacking direction. This makes it possible to further enhance a withstand voltage between the terminal electrodes.

In the present disclosure, the interlayer insulating film positioned between each of the first to fourth terminal electrodes and the low-permeability layer may have a larger film thickness than the interlayer insulating film positioned between a plurality of coil patterns. This makes it possible to further enhance a withstand voltage between the terminal electrodes.

A coil component according to the present disclosure may further include: third and fourth magnetic element bodies; third and fourth coil conductors embedded respectively in the third and fourth magnetic element bodies; fifth and sixth terminal electrodes exposed from the third magnetic element body and connected respectively to one end and the other end of the third coil conductor; seventh and eighth terminal electrodes exposed from the fourth magnetic element body and connected respectively to one end and the other end of the fourth coil conductor; and another low-permeability layer provided between the third and fourth magnetic element bodies and being lower in permeability than the third and fourth magnetic element bodies, and the first, second, third, and fourth magnetic element bodies may be arranged in this order. This allows an array product integrating two coupled inductors to be obtained.

In the present disclosure, the first, third, fifth, and seventh terminal electrodes may be arranged in this order. In this arrangement, the distance between the third and fifth terminal electrodes may be larger than the distance between the first and third terminal electrodes and the distance between the fifth and seventh terminal electrodes. This makes it possible to further enhance a withstand voltage between different coupled inductors.

As described above, according to the present disclosure, there can be provided a coil component capable of achieving a high inductance and easily adjusting a coupling coefficient.

What is claimed is:

1. A coil component comprising:
first and second magnetic element bodies;
first and second coil conductors embedded respectively in the first and second magnetic element bodies;
first and second terminal electrodes exposed from the first magnetic element body and connected respectively to one end and other end of the first coil conductor;
third and fourth terminal electrodes exposed from the second magnetic element body and connected respectively to one end and other end of the second coil conductor; and
a low-permeability layer provided between the first and second magnetic element bodies and being lower in permeability than the first and second magnetic element bodies.

2. The coil component as claimed in claim 1,
wherein each of the first and second coil conductors includes a plurality of coil patterns stacked through an interlayer insulating film,
wherein the first and second terminal electrodes are separated from the first magnetic element body through the interlayer insulating layer, and
wherein the third and fourth terminal electrodes are separated from the second magnetic element body through the interlayer insulating layer.

3. The coil component as claimed in claim 2, wherein the plurality of coil patterns are stacked in an arrangement direction of the first and second magnetic element bodies.

4. The coil component as claimed in claim 3, wherein a distance between the first and third terminal electrodes in a stacking direction is larger than a distance between the first and second coil conductors in the stacking direction.

5. The coil component as claimed in claim 3, wherein the interlayer insulating film positioned between each of the first to fourth terminal electrodes and the low-permeability layer has a larger film thickness than the interlayer insulating film positioned between a plurality of coil patterns.

6. The coil component as claimed in claim 1, further comprising:
third and fourth magnetic element bodies;
third and fourth coil conductors embedded respectively in the third and fourth magnetic element bodies;
fifth and sixth terminal electrodes exposed from the third magnetic element body and connected respectively to one end and other end of the third coil conductor;
seventh and eighth terminal electrodes exposed from the fourth magnetic element body and connected respectively to one end and other end of the fourth coil conductor; and
another low-permeability layer provided between the third and fourth magnetic element bodies and being lower in permeability than the third and fourth magnetic element bodies,
wherein the first, second, third, and fourth magnetic element bodies are arranged in this order.

7. The coil component as claimed in claim 6,
wherein the first, third, fifth, and seventh terminal electrodes are arranged in this order, and
wherein a distance between the third and fifth terminal electrodes is larger than a distance between the first and third terminal electrodes and a distance between the fifth and seventh terminal electrodes.
